(19) United States
(12) Patent Application Publication
(10) Pub. No.: US 2026/0105763 A1
(43) Pub. Date: Apr. 16, 2026

(54) AUTOMATED CELL MANUFACTURING METHODS AND SYSTEMS

(71) Applicant: Aspen Neuroscience, Inc., San Diego, CA (US)

(72) Inventors: William S ANSARI, San Diego, CA (US); Derren BARKEN, San Diego, CA (US); Michael J PESAVENTO, Berkeley, CA (US); Cullen George PIVAROFF, San Diego, CA (US); Ha TRAN, San Diego, CA (US)

(73) Assignee: Aspen Neuroscience, Inc., San Diego, CA (US)

(21) Appl. No.: 19/340,314

(22) Filed: Sep. 25, 2025

Related U.S. Application Data
(60) Provisional application No. 63/698,955, filed on Sep. 25, 2024.
(60) Provisional application No. 63/800,662, filed on May 6, 2025.

(51) Int. Cl. G06V 20/69; G06V 10/75; G06V 10/764; G06V 10/82

(52) U.S. Cl. CPC G06V 20/695; G06V 10/751; G06V 10/764; G06V 10/82

(57) ABSTRACT

The invention provides systems and methods for automated identification and isolation of cells. In some embodiments, the system receives an image of a cell culture, the image having a plurality of pixels. The system applies a machine learning model to classify at least a first subset of the plurality of pixels by assigning, for each pixel, a confidence value corresponding to each of one or more classes, where the class for each pixel is determined using the confidence values and feature(s) of surrounding pixels. The system generates a cell map based on the classe(s) of the pixels, and uses the cell map to cause a robotic device to perform operation(s) on the cell culture.

### CROSS-REFERENCE TO RELATED APPLICATIONS

This application claims the benefit of U.S. Provisional Patent Application No. 63/800,662, filed May 6, 2025, and U.S. Provisional Patent Application No. 63/698,955, filed Sep. 25, 2024, both entitled “Automated Cell Manufacturing Methods and Systems,” the entire contents of each of which are incorporated herein by reference.

### FIELD

The present application generally relates to automated cell manufacturing methods and systems, and specifically to the use of artificial intelligence (AI) in automated cell identification, classification, and handling.

### BACKGROUND

Stem cells, such as pluripotent stem cells (PSCs), are useful as a source of cells for many applications in regenerative medicine. For example, one can differentiate PSCs into specific cell populations that are contemplated for use in cell replacement therapies for patients with diseases resulting in a loss of function of a defined cell population. One such disease for which cell replacement therapies may prove effective is Parkinson's disease, which is a debilitating condition that is not adequately addressed with current therapeutic methods or treatments. According to some reports, Parkinson's disease is the 2nd most common neurodegenerative disease, affecting millions worldwide. Often it results from the loss of a single cell type in a localized part of the brain that is responsible for the development of disease symptoms. By the time of diagnosis, it is estimated that the majority of these dopamine-producing neurons in the substantia nigra have already been lost. Current methods of intervention (to the extent they exist) cannot prevent further degradation and loss of the dopamine-producing neurons. However, cell replacement therapy to replace dopamine producing neurons offers a promising path to treatment. Accordingly stem cell-derived dopaminergic neuronal precursor cells are needed for the treatment of Parkinson's disease.

Pluripotent stem cells (PSCs) have the ability to undergo self-renewal and give rise to all cells of the tissues of the body. PSCs include two broad categories of cells: embryonic stem (ES) cells and induced pluripotent stem cells (iPSCs). ES cells are derived from the inner cell mass of preimplantation embryos and can be maintained indefinitely and expanded in their pluripotent state in vitro. Romito and Cobellis, Stem Cells Int. (2016) 2016:9451492. Recently, preliminary results were reported for a phase I clinical trial that involved implanting dopaminergic neuronal cells obtained by differentiation of ES cells into the brains of patients with Parkinson's disease (Tabar et al. (2025) Nature DOI: 10.1038/s41586-025-08845-y). The results showed that the strategy was well tolerated, with no serious adverse effects related to the treatment. Preliminary efficacy data indicated improvements in motor functions. Despite these advances, the use of embryonic stem cells is plagued by ethical concerns, as well as the possibility that such cells may form tumors in patients. Finally, ES cell-derived transplants may cause immune reactions in patients in the context of allogeneic stem cell transplant.

Induced pluripotent stem cells (iPSCs) are another source of stem cells that are useful for generating neuronal progenitor cells for treating Parkinson's disease. Sawamoto et al. (2025) Nature DOI: 10.1038/s41586-025-08700-0. iPSCs have certain advantages over ES-derived cells, such as avoiding potential ethical concerns associated with embryonic stem cells. Further, derivation of iPSCs from a patient to be treated (i.e., the patient receives an autologous cell transplant) avoids risks of immune rejection inherent in the use of embryonic stem cells. iPSCs can be obtained by reprogramming (“dedifferentiating”) adult somatic cells to become more ES cell-like, including having the ability to expand indefinitely and differentiate into all three germ layers. Id. Such reprogramming is often accomplished using the “Yamanaka factors. (Oct 3/4, Sox2, Klf4, and a Myc family member). See, e.g., U.S. Pat. No. 8,530,238.

An often rate-limiting step in the production of stem cell-derived cells for use in cell replacement therapy is the production of iPSCs. For autologous cell therapies in particular, for which iPSCs and resulting differentiated cells must be prepared specifically for each individual patient, the need for automated, scalable methods and systems for producing iPSCs is particularly acute. Such systems and methods could, for example, reduce the time and/or resources, including costs, required for manufacturing iPSCs and cells differentiated from the iPSCs. The present invention fulfils these and other needs.

### SUMMARY

The present invention provides systems, algorithms and methods for automated identification and selection of desired cell types. As an example, the invention is useful for automated identification, selection, and isolation of induced pluripotent stem cells (iPSCs). Another aspect of the present disclosure provides a system comprising one or more computer processors and computer memory coupled thereto that are programmed to carry out the algorithms and methods of the invention. The computer memory comprises machine executable code that, upon execution by the one or more computer processors, implements any of the methods above or elsewhere herein.

In one aspect of the invention, a system is disclosed that includes one or more processors, and memory operably coupled to the one or more processors. The memory stores a machine learning model that is configured to classify pixels of an image of a cell culture into one or more classes based on one or more features of surrounding pixels. The system is configured to receive an image of a cell culture using an image capture device, the image having a plurality of pixels. The system is configured to apply the machine learning model to classify at least a first subset of the plurality of pixels by assigning, for each pixel of the first subset, a confidence value corresponding to each of the classe(s), wherein the class for each pixel of the first subset is determined using the confidence values and the feature(s) of the surrounding pixels. The system is configured to next generate a cell map based on the class or classes of the first subset of the plurality of pixels, and use the cell map to cause a robotic device to perform one or more operations on the cell culture. The one or more operations can include removing debris and/or undesired cells from around one or more desired cell colonies. The desired cell colonies are those cells having a high confidence value for a desired class. The operation(s) can also include obtaining from the cell culture an aliquot of cells of at least one of the one or more desired colonies.

In another aspect of the invention, a system is disclosed that includes one or more processors, and memory operably coupled to the one or more processors. The system is configured to train a first machine learning model to generate a trained machine learning model that is configured to classify pixels of a training image of a training cell culture into one or more classes based on one or more features of surrounding or other relevant pixels. Next, the system is configured to receive an image (e.g., a test image) of a cell culture (e.g., a test cell culture) using an image capture device, the image having a plurality of pixels. The system is then configured to apply the trained machine learning model to classify at least a first subset of the plurality of pixels by assigning, for each pixel of the first subset, a confidence value corresponding to each of the one or more classes, wherein the class for each pixel of the first subset is determined using the confidence values and the one or more features of the surrounding or other relevant pixels. Next, the system is configured to generate a cell map based on the class or classes of the first subset of the plurality of pixels, and use the cell map to cause a robotic device to perform one or more operations on the cell culture. The one or more operations can include, for example, removing debris and/or undesired cells from around one or more desired colonies that have a high confidence value for a desired class, and/or obtaining from the cell culture an aliquot of cells of at least one of the one or more desired colonies.

In another aspect of the invention, a method is disclosed. The method can include receiving an image of a cell culture using an image capture device, the image having a first plurality of pixels. The method can include applying a machine learning model to classify each pixel of at least a first subset of the plurality of pixels by assigning, for each pixel of the first subset, a confidence value corresponding to each of one or more classes, wherein the class for each pixel is determined using the confidence values and one or more features of surrounding pixels. The method can include generating a cell map based on the class or classes of the first subset of pixels, and using the cell map to cause a robotic device to perform one or more operations on the cell culture. The one or more operations can include removing debris and/or undesired cells from around one or more desired colonies that include cells having a high confidence value for a desired class, and obtaining from the cell culture an aliquot of cells of at least one of the one or more desired colonies.

In another aspect of the invention, a method is disclosed. The method can include training a first machine learning model to generate a trained machine learning model that is configured to classify pixels of a training image of a training cell culture into one of a plurality of classes based on one or more features of surrounding or other relevant pixels. The method can include receiving an image of a cell culture using an image capture device, the image having a plurality of pixels. The method can include applying the trained machine learning model to classify at least a first subset of the plurality of pixels by assigning, for each pixel of the first subset, a confidence value corresponding to each of the plurality of classes, wherein the class for each pixel of the first subset is determined using the confidence values and the feature(s) of the surrounding or other relevant pixels. The method can include generating a cell map based on the class or classes of the first subset of pixels, and using the cell map to cause a robotic device to perform one or more operations on the cell culture. The one or more operations can include removing debris and/or undesired cells from around one or more desired colonies that have a high confidence value for a desired class, and obtaining from the cell culture an aliquot of cells of at least one of the one or more desired colonies.

In some embodiments, the automated cell identification and handling systems described herein are used in conjunction with automated differentiation protocols, such as those described in U.S. patent application Ser. No. 19/238,348, filed Jun. 13, 2025, entitled “Automated Methods for Differentiating Dopaminergic Neurons from Stem Cells,” to facilitate the identification, selection, and transfer of pluripotent stem cells, spheroids, and differentiated neuronal progenitor cells during manufacturing

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.”herein), of which:

FIG. 1 shows a schematic of a workflow for manual iPSC production.

FIG. 2A shows the cleaning of fibroblasts away from emerging iPSC colonies.

FIG. 2B shows the cutting of iPSC colonies for transfer to a new culture.

FIG. 3A and FIG. 3B illustrate an example of removing undesired cells from around desired iPSCs using manual input of a human-devised cleaning path into a platform obtained from Cell X Technologies, Inc. FIG. 3A shows colonies before cleaning. FIG. 3B shows iPSC colonies after cleaning using manually-input cleaning parameters. Arrows point to iPSC colonies before and after cleaning.

FIG. 4A and FIG. 4B show identification of emerging iPSC colonies using the software provided with the Cell X Technologies apparatus. FIG. 4A shows cells before the analysis, and FIG. 4B shows the cell colonies after processing using the commercially available analysis package.

FIGS. 5A and 5B show automated selection of preferred colonies for further processing, according to aspects of the present disclosure. FIG. 5A shows the image before use of the image processing technology of the invention, and FIG. 5B shows the results of the image processing obtained using the systems and methods of the invention.

FIG. 6 shows cleaning paths that were autonomously generated around iPSC colonies, according to aspects of the present disclosure.

FIGS. 7A and 7B show before (A) and after (B) automated cleaning, demonstrating successful removal of fibroblasts around emerging iPSC colonies, according to aspects of the present invention.

FIG. 8 shows results obtained using a multi-class segmentation algorithm that is capable of discerning high quality iPSCs using artificial intelligence-based image analysis, according to aspects of the present invention. Cells are classified as iPSCs (iPSC Class), differentiated cells (Differentiation Class), or unknown (Unknown Class).

FIGS. 9A-9C show the enrichment of iPSCs in a single passage using a multi-class segmentation algorithm, according to aspects of the present disclosure. FIG. 9A shows cells classified as iPSCs, which classification was confirmed by expression of iPSC-specific markers (not shown). FIG. 9B shows cells classified as unknown type and not iPSCs; again, this classification was confirmed by lack of expression of markers that are characteristic of iPSCs (not shown). FIG. 9C shows cells classified as differentiated cells (e.g., fibroblasts) and not iPSCs, again as confirmed by lack of expression of markers that are characteristic of iPSCs (not shown).

FIG. 10 shows an example system that is programmed or otherwise configured to implement methods provided herein, according to aspects of the present disclosure.

FIG. 11 is an example computing system, according to aspects of the present disclosure.

FIG. 12 is an example robotic device, according to aspects of the present disclosure.

FIG. 13 shows an example cell culture image divided into a plurality of sections for use in pixel-by-pixel classification, according to aspects of the present disclosure.

FIG. 14 is a flowchart of an example method for automated classification and handling of cells, according to aspects of the present disclosure.

FIG. 15 shows a flowchart of an example method for automated classification and handling of cells, according to aspects of the present disclosure.

### DETAILED DESCRIPTION

While various embodiments of the invention have been shown and described herein, it will be understood to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

In some cases, described herein are methods focused on developing, manufacturing and delivering autologous cell therapies, which are developed from the patient's own induced pluripotent stem cells (iPSCs). In some cases, provided herein are methods that classify a plurality of cells and enrich for cell clones of interest, e.g., iPSCs. In some cases, provided herein are methods that segmentate a plurality of cells and enrich for cell clones of interest, e.g., iPSCs. Methods provided herein may simplify and shorten the process of the classification, the segmentation, and the enrichment of cell clones of interest. Methods provided herein may be used for iPSC programming and culturing. In some embodiments, methods provided herein operate on an open plate.

An example case is referred to as ANPD001, which is an autologous cell therapy composed of dopaminergic neuronal precursor cells (DANPCs). This example was produced with a goal of replacing lost dopamine-producing neurons in the brains of people with Parkinson's disease, according to a specific treatment workflow. Such treatment workflow provides an approach for treating Parkinson's disease using autologous cell replacement therapy composed of DANPCs to replace lost dopamine-producing neurons in the brains of people having Parkinson's disease. The workflow begins with harvesting cell cultures from a human patient, and reprogramming the harvested cells into iPSCs. These iPSCs can then be turned into DANPCs, which can then be transplanted back into the human patient.

Such a workflow can benefit further from automation in iPSC production. As such, the present invention provides systems and methods for taking manual expertise and making it scalable, faster, and cheaper for patients through automation. In some aspects, automation described herein can focus on translating manual subject matter expert driven processes into a robotic process which require reduced, or even no supervision by a trained expert.

In some aspects, described herein are algorithms and/or platforms which deploy artificial intelligence (e.g., through any machine learning process described herein) in the manufacturing process for cell therapeutics. In some cases, such platforms bridge a gap between man and machine to develop completely autonomous or nearly autonomous manufacturing. In one example automation strategy, according to embodiments described herein, production of stem cell-derived cell replacement products can be transformed from an aseptic manual research and development-stage process, to a ready-to-commercialize process, and finally to an end-to-end closed and/or automated manufacturing process that can be deployed globally. The initial research and development-stage process requires adaptation to good manufacturing practices (GMP), assessment of patient-to patient variability, and manual, open, aseptic manufacturing. Such process can support hundreds of patients. The ready-to-commercialize process can support more patients than can the initial research and development-stage process, and requires stepwise improvements in manufacturing to increase efficiency and reduce costs. It also requires semi-closed steps and automation, and can be used to qualify and validate analytics of process improvements. Such ready-to-commercialize process can be at least semi-automated. In the end-to-end process, thousands of patients can be supported which increases the overall annual scale and capacity of the process. The end-to-end process provides for closed and fully automated development of an autologous cell therapy manufacturing system that can be deployed globally. Such end-to-end process can be closed and/or automated, has the ability to plug-and-play in any facility worldwide, and is designed with inputs derived from bioinformatics platform such that it can incorporate the clinical data.

The invention addresses challenges such as enabling production of a large quantity of cells for each patient, and/or to produce small quantities of cells for many patients in parallel. In some cases, cell numbers in the millions for each subject or patient can be sufficient for treatment of the subject or patient. In some cases, a template for automation that provides for treatment of hundreds of patients annually can be used to scale out to the thousands of patients.

In some embodiments, automation challenges for autologous iPSC-based therapy manufacturing can include scaling between: autologous vs allogeneic scale differences; milliliter scale vs. liter scale; millions of cells vs. billions of cells; process length and adaptation; and prevention of cross contamination.

Devices, systems, and methods described herein may comprise cell culture unit operations such as cell selection (positive or negative), feeding, and/or passaging. In addition, the reprogramming step to iPSCs has some unique processes like cell selection and colony cleaning that is not part of all other cell therapy products.

There are various potential automation targets involved for production of iPSC-derived dopaminergic neuronal progenitor cells (DANPCs), starting from differentiated cells such as fibroblasts. Stage 1 involves producing isolated fibroblasts from skin biopsies. Stage 2 can involve the reprogramming of fibroblasts to iPSCs. Stage 3 of the process involves differentiation of the iPSCs to DANPCs. In some embodiments, automation modules and platforms described herein can comprise modules which perform: isolation, cell/clone selection (e.g., select/pick then clean), expansion (e.g., feed, passage, harvest), and/or fill / finish and combinations thereof.

Over the last 10 years there has been an evolution in cell therapy manufacturing from single unit operation automation to multi-unit operation devices and in the last few years from bench top automation systems to larger scale automation systems that move from single batch to multi batch. These systems are primarily designed for suspension cultures like T-cells and HPSCs like CD34⁺ cells. Some of these systems are potentially useful for the differentiation stage of manufacturing, but automating iPSC production is problematic for previously known automation systems. For example, because autologous iPSC production may proceed at different rates in different patients, it would be impossible to use fixed decision points in a scheduler, so scheduling would need to be flexible. Image analysis and decision-making software development is also needed to determine which cells are the correct ones to pick and which are the best to carry forward.

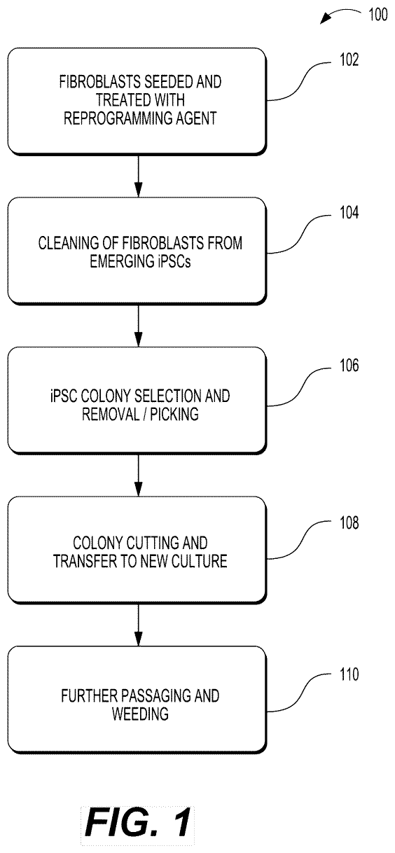

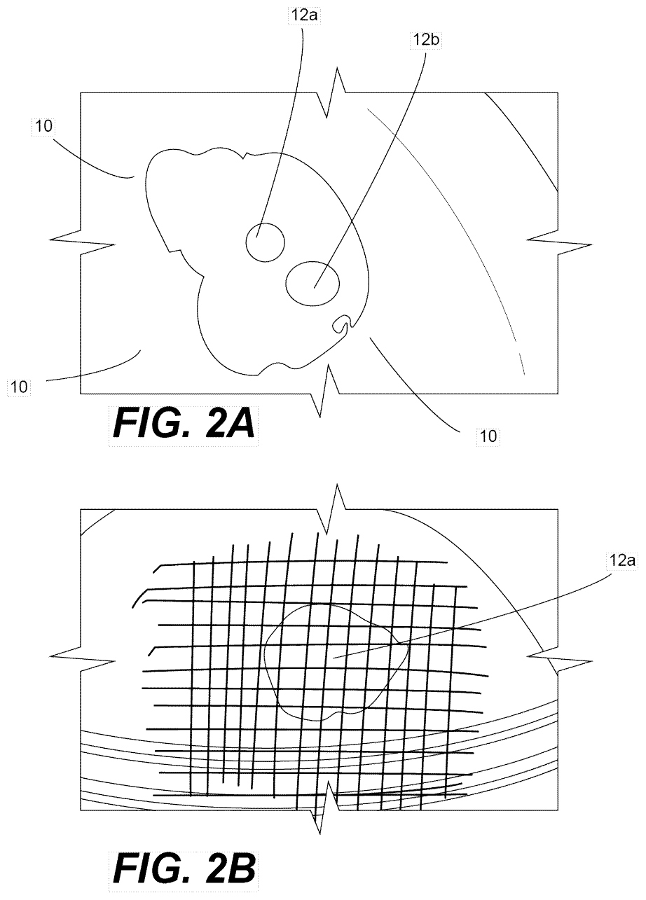

A generalized workflow 100 for manual iPSC production is illustrated in FIG. 1. In some aspects of this disclosure, manual iPSC production steps, which conventionally required highly trained subject matter experts, are now automated. For example, in some cases, as shown in block 102, fibroblasts are cultured and then treated with a reprogramming agent. After several weeks, fibroblasts must be cleared away from the emerging colonies of iPSCs, in block 104. In block 106, differentiated portions of the iPSC colonies must be identified by trained technicians and removed (“picking”). Once large enough, in block 108, iPSC colonies are cut into small pieces and transferred onto a new plate. In block 110, plates are further passaged and differentiated portions cleared away (“weeding”) until the iPSC line is stable. This process can take approximately two or more months when performed manually, however, methods of this disclosure can greatly increase the speed. The cleaning of fibroblasts away from emerging colonies (block 104) is illustrated in FIG. 2A. For example, fibroblasts 10 are cleared away from colonies 12a, 12b. FIG. 2B then illustrates cutting iPSC colonies, such as colony 12a, to transfer to a new culture.

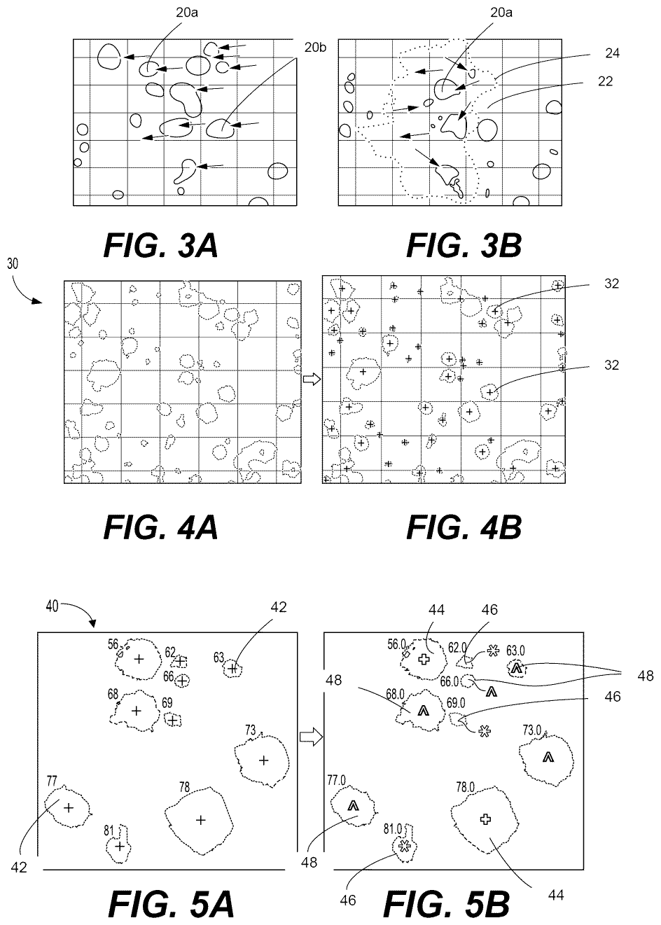

FIGS. 3A and 3B illustrate cleaning of differentiated cells (e.g., fibroblasts) from around desired iPSC colonies using an apparatus obtained from Cell X Technologies, Inc. For example, desired iPSC colonies 20 (e.g., 20a, 20b) can first be identified, as shown in FIG. 3A. Fibroblasts 22 can then be cleared away from the colonies 20, as depicture by the dotted line 24 in FIG. 3B. The cleaning path was manually input into the control software by an operator, with the objective of removing differentiated cells and allowing room for selected colonies to continue to grow. Although this method resulted in successful cleaning, as shown by FIG. 3A (before cleaning) and FIG. 3B (after cleaning), a skilled operator is required to devise and input the cleaning path. FIGS. 4A and 4B show an example of iPSC identification using the commercially available system from Cell X Technologies, Inc. As shown, upon taking an image of a cell culture 30 (FIG. 4A), such existing system can be used to identify iPSCs, as identified with a plus (+) sign (e.g., iPSCs 32) in FIG. 4B.

To address challenges in existing cell identification and handling processes, the present invention provides, in some embodiments, systems and methods that use artificial intelligence (AI) in the automated manufacturing of iPSCs or other cell lines. Deep learning neural networks have tremendous potential to capture the expertise of human operators. This type of segmentation algorithm can be utilized to remove off-target cells. Such algorithms can be employed for confluency measurements and for making decisions regarding whether to feed or passage the culture. Furthermore, the use of classifier algorithms to rank the quality of derived cells is possible. In both scenarios, the robustness of these algorithms necessitates the development of high-quality training data sets, a process that can be complex and time-consuming.

The development of a protocol for end-to-end process automation, from the thawing of fibroblasts to the harvest of iPSCs, is discussed herein. The concept of fully autonomous device operation is described, as well as examples of integration of computer vision systems with robotic controls for cell manufacturing. The combination of AI development with multi-omics and QC datasets is discussed. The topic of clone quality ranking and iPSC maturity prediction is addressed, along with the reduction of manufacturing redundancy and the shortening of process duration.

In some cases, a specific number of clones is started with in the early passages and ones to drop are selected as the manufacturing process proceeds. The approach can be adjusted either by selecting more clones upfront and paring down quickly or selecting fewer and paring down less throughout the process, to achieve a “clone funnel”.

The integration of image algorithm development with quantitative analytical data is another aspect of this disclosure. A process characterization effort using a multi-omics approach can correlate this data with image data to make the clone quality prediction algorithms even more robust. This can ultimately aid in reducing the cost of goods through the reduction of manufacturing redundancy and duration. Reduction of “on platform time” can enhance capacity to make these therapies more accessible to patients, which is a goal of this disclosure.

FIGS. 5A and 5B illustrate the use of the AI-based systems and methods of the present invention for automated selection of preferred colonies for further processing, showing a filter and sort applied to the segmentation of emerging iPSC colonies. FIG. 5A shows an image 40 prior to processing, with cell colonies 42 identified. FIG. 5B shows the image after a filter and sort algorithm based on morphological attributes and other segmentation map features that correlate with quality was applied to automatically generate a list of preferred colonies for downstream processing. Preferred colonies 44 are highlighted with a plus sign (+), while those colonies excluded based on failing the filter criteria 46 are marked with an asterisk (*). Caret symbols (∧) mark colonies 48 which would pass the filter criteria but are within a critical distance of higher ranked preferred (+) colonies, meaning they would be destroyed in the process of cleaning.

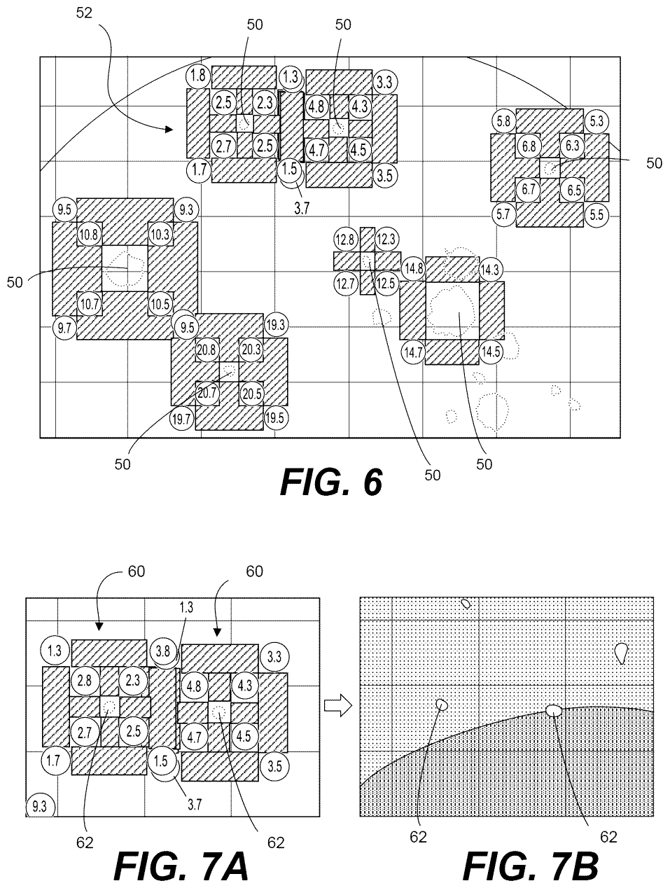

FIG. 6 illustrates the use of an algorithm of the invention for successful and efficient automated cleaning around emerging iPSC colonies using automated generation of a robotic cleaning path. For example, a cleaning path 52 can be generated around each emerging iPSC colony 50. Cleaning paths were generated algorithmically from a segmentation map and a downstream filter/sort process, successfully replicating and or improving clearance of fibroblasts around emerging colonies seen with manually drawn paths. The cleaning pattern is drawn autonomously around the segmented and selected iPSC colonies after the filter and sort process. Preferred colonies are identified and then a pipette track is automatically drawn around the outside border, to ensure that after cleaning is complete, there are few or no fibroblasts remaining to contaminate the culture which allows clean picking to the next plate. Compared to the manual process, the segmentation and cleaning path provided herein may simplify and shorten the cleaning process by at least 1 minute, by at least 5 minutes, by at least 10 minutes, by at least 30 minutes, by at least 1 hour, by at least 1.5 hours, by at least 2 hours, by at least 3 hours, by at least 4 hours, by at least 5 hours.

FIGS. 7A and 7B illustrate the before and after of the automated cleaning showing successful removal of fibroblasts and other types of unwanted cells. Cleaning paths were generated algorithmically from a segmentation map and downstream filter/sort, successfully replicating the clearance of fibroblasts around emerging colonies seen with manually drawn paths. For example, as shown in FIG. 7A, a cleaning path 60 can be generated around each emerging colony 62. The cleaning paths may be generated from cleaning spots that are points selected based on a mathematical formula. The cleaning paths may comprise an inner box that closely surrounds the desired clones. The cleaning paths may comprise an outer box that covers the area of the inner box. In some embodiments, the shape of the inner box and the outer box is square. In some embodiments, the shape of the inner box and the outer box is not square. In some embodiments, the shape of the inner box and the outer box is a closed polygon, circle, rectangle, triangle, ellipse, parallelogram, rhombus, pentagon, hexagon, heptagon, octagon, nonagon, decagon, kite, or other shape. In some embodiments, the shape of the inner box and the outer box is irregular. In some aspects, the automated cleaning changes direction during cleaning. In some embodiments, the direction changes for 90 degrees. In some embodiments, the size of the cleaning spots are not constant. As shown in FIG. 7B, the majority of fibroblasts were cleared away from the periphery of the selected colonies 62, indicating successful cleaning. This is a major step forward to autonomously perform the early portions of reprogramming. After the automated cleaning process, the selected colony can grow larger.

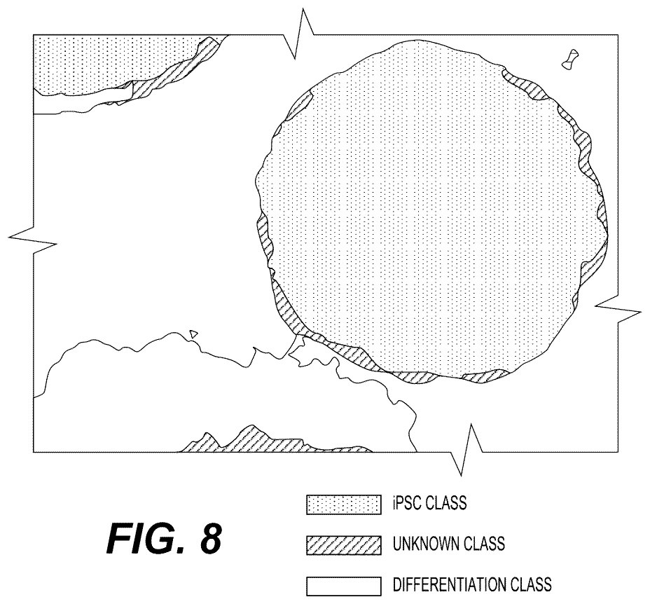

FIG. 8 illustrates an example of results obtained using a multi-class segmentation algorithm that is capable of discerning high quality iPSCs from cells of an unknown class or a differentiation class. An example model was implemented and integrated into live process runs. This model was used as primary basis for autonomous decision-making and robotic control from the first plate in the process onward, which also allowed quality metrics to be gathered from in-process iPSCs. Confluency, morphological quality, and percent of differentiation can be used to determine next steps in any process described herein, for example, for targeting robotic interventions, or to justify early clone termination.

In addition, classifier algorithms can be used to rank quality of derived cells. An example AI-based multiclass segmentation model was implemented for assessment of in-process iPSC cultures. This version of the algorithm incorporated four classes: background, iPSC, unknown cells, and differentiated cells. The example model which was implemented performs the bulk of the autonomous process decision-making. This may comprise everything from choosing which cells to move forward with, which to remove, or providing assessments of in process quality of clones. This example computer vision system is the primary basis of process decision-making from the establishment of a clonal iPSC culture until cryopreservation.

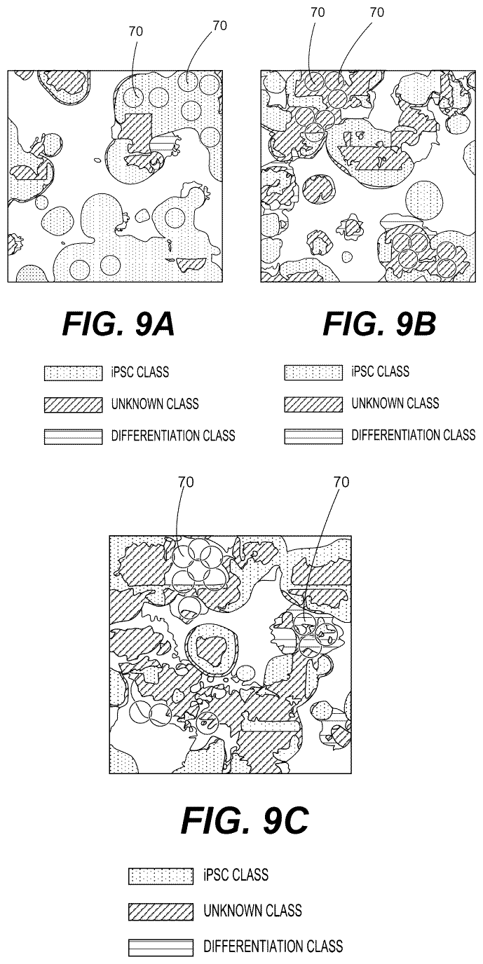

FIGS. 9A, 9B, and 9C show an example implementation of a machine learning model described herein in use. This experiment tracked a single passage of a relatively differentiated P1 culture. The model was used to analyze the culture and automatically select robotic pick points 70 (shown as circles). Picking was performed by the example robotic platform, and the cells were then cultured for several days to run flow cytometry. The classifications were confirmed by a significant difference in expression of pluripotency markers tra1/81 and oct3/4 between the different classes (not shown), with the iPSC class showing the highest levels of tra1/81 and oct3/4 and unknown and differentiated classes showing significantly lower expression. This is an encouraging proof of concept for autonomous operation of the process, and the model passed this test.

These types of segmentation algorithms can then be used to remove the off-target cells. Segmentation algorithms can also be used for confluency measurements and decisions on whether to feed or passage the culture. In addition, classifier algorithms can be used to rank quality of derived cells.

### Computing Systems

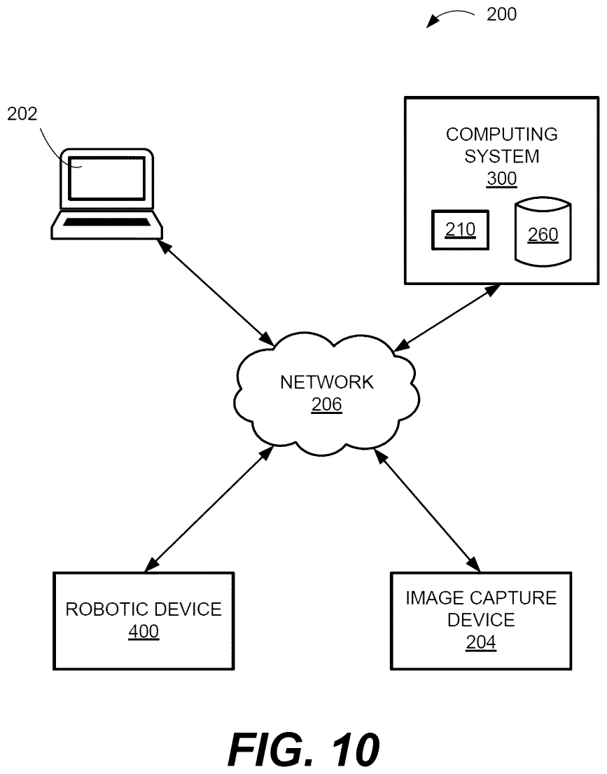

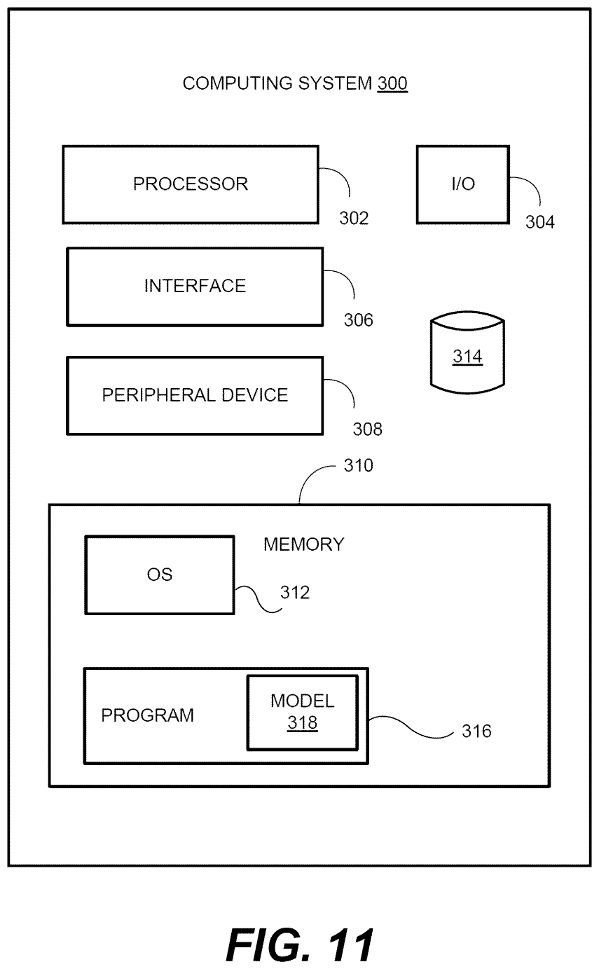

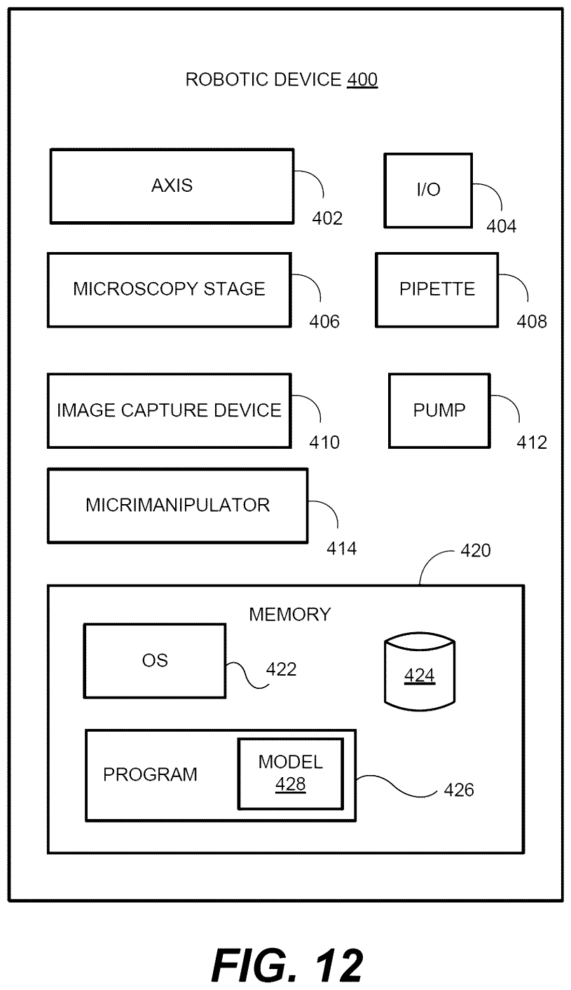

FIG. 10 shows an example system 200 that can be used to implement the methods of the present disclosure. System 200 includes a user device 202, a computing system 300 (FIG. 11), a robotic device 400 (FIG. 12), and an image capture device 204 (e.g., a microscope). As shown, these components can communicate with one another over a network 206, that can be the Internet, an internet and/or extranet, or an intranet and/or extranet that is in communication with the Internet. The network 206 in some cases is a telecommunication and/or data network. The network 206 can include one or more computer servers, which can enable distributed computing, such as cloud computing. The network 206, in some cases with the aid of the computing system 300, can implement a peer-to-peer network, which may enable devices coupled to the computing system 300 to behave as a client or a server.

System 200 can be programmed or otherwise configured to perform segmentation and/or classification of one or more images of a cell population, and/or to provide automatic selection of a cleaning path to a cell manufacturing robot, e.g., robotic device 400.

Computing system 300 can regulate various aspects of cell manufacturing by methods and systems of the present disclosure, such as, for example, automatic selection of a cleaning path and/or automatic production of therapeutic iPSCs. The computing system 300 can be an electronic device of a user or a computer system that is remotely located with respect to the electronic device. The electronic device can be a mobile electronic device.

As shown in FIG. 11, the computing system 300 includes a central processing unit (CPU, also “processor” and “computer processor” herein) 302, which can be a single core or multi core processor, or a plurality of processors for parallel processing. The computing system 300 can also include an input/output (I/O) device 304, a communication interface 306 (e.g., network adapter) for communicating with one or more other systems, one or more peripheral devices 308, such as cache, other memory, data storage and/or electronic display adapters, an electronic storage unit 314 (e.g., hard disk), and memory or memory location 310 (e.g., random-access memory, read-only memory, flash memory). The memory 310 can include an operating system (OS) 312, and one or more programs 316 that can include a machine learning model 318 that can be any of the models described herein. The memory 310, storage unit 314, interface 306, and peripheral device(s) 308 are in communication with the CPU 302 through a communication bus (solid lines), such as a motherboard. The storage unit 314 can be a data storage unit (or data repository) for storing data.

The CPU 302 can execute a sequence of machine-readable instructions, which can be embodied in a program (e.g., program 316) or software. The instructions may be stored in a memory location, such as the memory 310. The instructions can be directed to the CPU 302, which can subsequently program or otherwise configure the CPU 302 to implement methods of the present disclosure. Examples of operations performed by the CPU 302 can include fetch, decode, execute, and writeback.

The CPU 302 can be part of a circuit, such as an integrated circuit. One or more other components of the system 300 can be included in the circuit. In some cases, the circuit is an application specific integrated circuit (ASIC).

A graphics processing unit (GPU) is a specialized processing unit, electronic circuit, module, or computer chip, etc., that can accelerate digital image processing and many other applications, and is often present either as a discrete video card, or embedded on motherboards, or as integrated graphics on a CPU. Similarly, chip modules are known that can perform machine learning prediction (sometimes referred to as inference). Such chips include, for example, language processing units (LPUs), cloud tensor processing units (TPUs), neural engines, AI coprocessors, AI accelerators, and neural processing units (NPUs). In some embodiments, a GPU or other chip module performs at least some of the functions that could otherwise be performed by a CPU.

The storage unit 314 can store files, such as drivers, libraries and saved programs. The storage unit 314 can store user data, e.g., user preferences and user programs. The computing system 300 in some cases can include one or more additional data storage units that are external to the computing system 300, such as located on a remote server that is in communication with the computing system 300 through an intranet or the Internet.

The computing system 300 can communicate with one or more remote computer systems through the network 206. For instance, the computing system 300 can communicate with a remote computer system of a user (e.g., a lab technician or a treating physician), such as user device 202. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computing system 300 via the network 206.

Methods as described herein can be implemented by way of machine (e.g., computer processor) executable code stored on an electronic storage location of the computing system 300, such as, for example, on the memory 310 or electronic storage unit 314. The machine executable or machine readable code can be provided in the form of software. During use, the code can be executed by the processor 302. In some cases, the code can be retrieved from the storage unit 314 and stored on the memory 310 for ready access by the processor 302. In some situations, the electronic storage unit 314 can be precluded, and machine-executable instructions are stored on memory 310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computing system 300, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computing system 300 can include or be in communication with a computing device, such as user device 202, that includes an electronic display that comprises a user interface (UI) for providing, for example, evaluation of an image comprising a cell population, segmentation of such an image, and/or automatic determination of a cleaning path for a cell manufacturing robot. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 302. The algorithm can, for example, automatically select and clean cell colonies for production of a cell therapeutic.

FIG. 12 specifically shows the components of the robotic device 400. As discussed herein, the robotic device 400 may be controlled by one or more components of system 200, such as the computing system 300, to conduct extraction or pipetting of certain material or cells from a cell culture. As shown, robotic device 400 can include an axis 402, an I/O device 404, a microscopy stage 406, an air displacement pipette 408, an image capture device 410, a pump 412, and/or a micromanipulator 414. The robotic device 400 may also include its own memory 420, OS 422, storage device 424, program 426, and machine learning model 428.

### Machine Learning Models

Machine learning models of the disclosed technology (e.g., model 318 and/or 428) can be used for reading microscopy images and/or extracting information. The models can receive images from a microscopy source (e.g., image capture device 204), and send and receive images and metadata to and from a server (e.g., computing system 300).

A machine learning model incorporated in the systems and methods discussed herein can comprise a supervised, semi-supervised, unsupervised, or self-supervised machine learning model. In some examples, the machine learning approach comprises a classical machine learning method, such as, but not limited to, support vector machine (SVM) (e.g., one-class SVM, linear or radial kernels, etc.), K-nearest neighbor (KNN), isolation forest, random forest, logistic regression, AdaBoost classifier, extra trees classifier, extreme gradient boosting, gaussian process classifier, gradient boosting classifier, light gradient boosting, linear discriminant analysis, naïve Bayes, quadratic discriminant analysis, ridge classifier, or any combination thereof. In some examples, the machine learning approach comprises a deep leaning method (e.g., deep neural network (DNN)), such as, but not limited to a fully-connected network, convolutional neural network (CNN) (e.g., one-class CNN), recurrent neural network (RNN), transformer, graph neural network (GNN), convolutional graph neural network (CGNN), multi-level perceptron (MLP), or any combination thereof.

In some embodiments, a classical ML method comprises one or more algorithms that learns from existing observations (i.e., known features) to predict outputs. In some embodiments, the one or more algorithms perform clustering of data. In some examples, the classical ML algorithms for clustering comprise K-means clustering, mean-shift clustering, density-based spatial clustering of applications with noise (DBSCAN), expectation-maximization (EM) clustering (e.g., using Gaussian mixture models (GMM)), agglomerative hierarchical clustering, or any combination thereof. In some embodiments, the one or more algorithms perform classification of data. In some examples, the classical ML algorithms for classification comprise logistic regression, naïve Bayes, KNN, random forest, isolation forest, decision trees, gradient boosting, support vector machine (SVM), or any combination thereof. In some examples, the SVM comprises a one-class SMV or a multi-class SVM.

In some embodiments, the deep learning method comprises one or more algorithms that learns by extracting new features to predict outputs. In some embodiments, the deep learning method comprises one or more layers. In some embodiments, the deep learning method comprises a neural network (e.g., DNN comprising more than one layer). In some examples, the machine learning approach comprises a deep leaning method (e.g., deep neural network (DNN)), such as, but not limited to a fully-connected network, convolutional neural network (CNN) (e.g., one-class CNN), recurrent neural network (RNN), transformer, graph neural network (GNN), convolutional graph neural network (CGNN), multi-level perceptron (MLP), or any combination thereof. Neural networks generally comprise connected nodes in a network, which can perform functions, such as transforming or translating input data. In some embodiments, the output from a given node is passed on as input to another node. The nodes in the network generally comprise input units in an input layer, hidden units in one or more hidden layers, output units in an output layer, or a combination thereof. In some embodiments, an input node is connected to one or more hidden units. In some embodiments, one or more hidden units is connected to an output unit. The nodes can generally take in input through the input units and generate an output from the output units using an activation function. In some embodiments, the input or output comprises a tensor, a matrix, a vector, an array, or a scalar. In some embodiments, the activation function is a Rectified Linear Unit (ReLU) activation function, a sigmoid activation function, a hyperbolic tangent activation function, or a Softmax activation function. In some embodiments, the deep learning methods can include a Vision Transformer (ViT).

The connections between nodes can further comprise weights for adjusting input data to a given node (i.e., to activate input data or deactivate input data). In some embodiments, the weights are learned by the neural network. In some embodiments, the neural network is trained to learn weights using gradient-based optimizations. In some embodiments, the gradient-based optimization comprises one or more loss functions. In some embodiments, the gradient-based optimization is gradient descent, conjugate gradient descent, stochastic gradient descent, or any variation thereof (e.g., adaptive moment estimation (Adam)). In some further embodiments, the gradient in the gradient-based optimization is computed using backpropagation. In some embodiments, the nodes are organized into graphs to generate a network (e.g., graph neural networks). In some embodiments, the nodes are organized into one or more layers to generate a network (e.g., feed forward neural networks, convolutional neural networks (CNNs), recurrent neural networks (RNNs), etc.). In some embodiments, the CNN comprises a one-class CNN or a multi-class CNN.

In some embodiments, the neural network comprises one or more recurrent layers. In some embodiments, the one or more recurrent layers are one or more long short-term memory (LSTM) layers or gated recurrent units (GRUs). In some embodiments, the one or more recurrent layers perform sequential data classification and clustering in which the data ordering is considered (e.g., time series data). In such embodiments, future predictions are made by the one or more recurrent layers according to the sequence of past events. In some embodiments, the recurrent layer retains or “remembers” important information, while selectively “forgets”what is not essential to the classification.

In some embodiments, the neural network comprise one or more convolutional layers. In some embodiments, the input and the output are a tensor representing variables or attributes in a data set (e.g., features), which may be referred to as a feature map (or activation map). In such embodiments, the one or more convolutional layers are referred to as a feature extraction phase. In some embodiments, the convolutions are one-dimensional (1D) convolutions, two dimensional (2D) convolutions, three dimensional (3D) convolutions, or any combination thereof. In further embodiments, the convolutions are 1D transpose convolutions, 2D transpose convolutions, 3D transpose convolutions, or any combination thereof.

The layers in a neural network can further comprise one or more pooling layers before or after a convolutional layer. In some embodiments, the one or more pooling layers reduces the dimensionality of a feature map using filters that summarize regions of a matrix. In some embodiments, this down samples the number of outputs, and thus reduces the parameters and computational resources needed for the neural network. In some embodiments, the one or more pooling layers comprises max pooling, min pooling, average pooling, global pooling, norm pooling, or a combination thereof. In some embodiments, max pooling reduces the dimensionality of the data by taking only the maximums values in the region of the matrix. In some embodiments, this helps capture the most significant one or more features. In some embodiments, the one or more pooling layers is one dimensional (1D), two dimensional (2D), three dimensional (3D), or any combination thereof.

The neural network can further comprise of one or more flattening layers, which can flatten the input to be passed on to the next layer. In some embodiments, an input (e.g., feature map) is flattened by reducing the input to a one-dimensional array. In some embodiments, the flattened inputs can be used to output a classification of an object. In some embodiments, the classification comprises a binary classification or multi-class classification of visual data (e.g., images, videos, etc.) or non-visual data (e.g., analogue sensor measurements, etc.). In some embodiments, the classification comprises binary classification of an image (e.g., cat or dog). In some embodiments, the classification comprises binary classification of a measurement. In some examples, the binary classification of a measurement comprises a classification of a system's performance using the physical measurements described herein (e.g., normal or abnormal, normal or anormal).

The neural networks can further comprise of one or more dropout layers. In some embodiments, the dropout layers are used during training of the neural network (e.g., to perform binary or multi-class classifications). In some embodiments, the one or more dropout layers randomly set some weights as 0 (e.g., about 10%, 20%, 30%, 40%, 50%, 60%, 70%, 80% of weights). In some embodiments, the setting some weights as 0 also sets the corresponding elements in the feature map as 0. In some embodiments, the one or more dropout layers can be used to avoid the neural network from overfitting.

The neural network can further comprise one or more dense layers, which comprises a fully connected network. In some embodiments, information is passed through a fully connected network to generate a predicted classification of an object. In some embodiments, the error associated with the predicted classification of the object is also calculated. In some embodiments, the error is backpropagated to improve the prediction. In some embodiments, the one or more dense layers comprises a Softmax activation function. In some embodiments, the Softmax activation function converts a vector of numbers to a vector of probabilities. In some embodiments, these probabilities are subsequently used in classifications, such as classifications of a differentiation state of a cell or cell colony or classifications of one or more cell quality metrics of a cell or cell colony as described herein.

The machine learning model can comprise one or more sub-models. In some cases, the one or more sub-models are trained individually. In some cases, individual models are trained to each determine one or more of a plurality of cell quality metrics. In some embodiments, a single model is trained to directly determine a plurality of cell quality metrics in a single model.

The machine learning model can provide for iPSC multiclass segmentation whereby it identifies differences in iPSCs, differentiated cells, and those of unknown classification. In some embodiments, such multiclass segmentation may involve identifying low confidence iPSCs versus high confidence iPSCs. For example, as the model has higher confidence in a cell's identification as an iPSC, it may identify that cell as an iPSC. The model can also provide for rapid deployment and inference on large scale images. The model can run an inference on a single graphics processing unit (GPU), and can queue and run multiple processes. Such containerization provides scalability and load balancing as inference load increases (GPU work clusters).

In some embodiments, the machine learning model can conduct image correction, for example, to remove low-frequency brightness bias from images. Such image correction can be conducted by first dividing an image into a plurality of sections, each section having a plurality of pixels, taking the average luminance across all sections, and normalizing the per-section luminance by the mean section. Such image correction can also be conducted by blurring each section with a gaussian kernel, and normalizing each section by blurred luminance. Image correction can also be conducted by identifying and storing empty or “blank”section images.

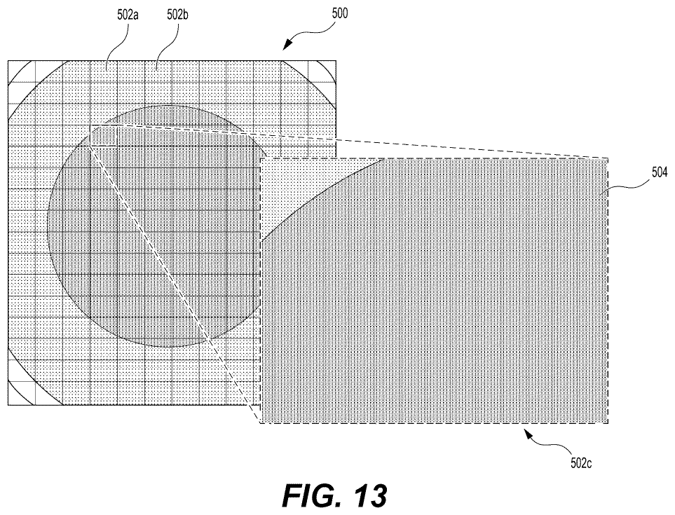

In some embodiments, the machine learning model provides pixel by pixel classification for the pixels contained in a microscope image. For example, FIG. 13 shows an example of an image 500 of a cell culture that is divided into a plurality of sections 502 (e.g., 502a, 502b, 502c). Within each section 502 is a plurality of pixels 504. As further discussed below, as the model receives the image, the machine learning model can be configured to continuously make predictions as to a classification of the cells contained in each section 502 based on that section's respective pixels 504. After the model has made a prediction for all sections 502 within the image, the sections 502 can be put together to form a montage or collection of the predicted sections 502. Such montage or collection can then be sent to software that controls a robotic device (e.g., robotic device 400) that performs one or more operations on the cell culture, such as removing one or more of debris and undesired cells from around one or more desired colonies, the desired colonies including cells having a high confidence value for a desired class, and/or obtaining from the cell culture an aliquot of cells of at least one of the desired colonies. In making its predictions, the model calculates a numerical confidence value for each pixel—the highest confidence value determines the classification for that pixel. Each pixel has four confidence values, for each of the four possible classes (iPSC, differentiated, unknown, background); the four confidence values sum to 1. The model calculations are carried out via a software package.

The model can be configured to use the (per pixel) confidence values for the iPSC class to identify a subset of the iPSC pixels, identified as a distinct “Desired iPSC” class. The “Desired iPSC” pixels are intended to be just enough to provide, in the aggregate, a set of N requested pick points. In some embodiments, choosing “Desired iPSC” pixels is a dynamic process—the minimum confidence value (i.e., the threshold) is not fixed. In such embodiments, the confidence threshold for which pixels can be classified as “Desired iPSC” is set dynamically through ranking N pick points in decreasing order of confidence, with the minimum confidence for the Nth pick point setting the threshold. This will give a selection of “Desired iPSC” classified pixels sufficient to generate the requested pick points but always giving preference to the best available iPSC pixels as ranked by the confidence values. In some embodiments, in addition to the dynamically determined confidence threshold discussed above, the system may also be configured to apply a minimum fixed confidence threshold for selecting the desired pixels.

For the model to identify which of the iPSC pixels are “Desired iPSC”, it will take several inputs: (i) the number of pick points requested (N), (ii) the diameter(s) of the pick points, and (iii) additional constraints such as a minimum distance to the nearest differentiated/unknown/background pixel or a minimum distance to a pixel that does not have a high confidence value for a desired class. In some embodiments, the unknown or low confidence iPSCs can be included in the number of pick points requested (N), for example, as not enough high confidence iPSC material may be available at that point. In such embodiments, unknown or low confidence iPSCs can also be included in selected the pick point diameter(s). Thus, the more pick points are requested, the more “Desired iPSC” pixels will be designated by the model, and thus the lower the minimal confidence value among the designated “Pickable iPSC pixels”. In some embodiments, a request for pick points may not be satisfied—if there are insufficient iPSC pixels, it may not be possible to designate sufficient “Desired iPSC” pixels as a class for pick point selection.

In some embodiments, a secondary “fixed minimum” confidence value may optionally be used either/or in addition to the above-described process.

Further optional features that can be incorporated into the disclosure are described in US2023377685A1, WO23201361A1, EP4038181A1, US2022254448A1, WO21016607A1, WO23004371A1, and/or U.S. Pat. No. 8,442,772.

### Methods

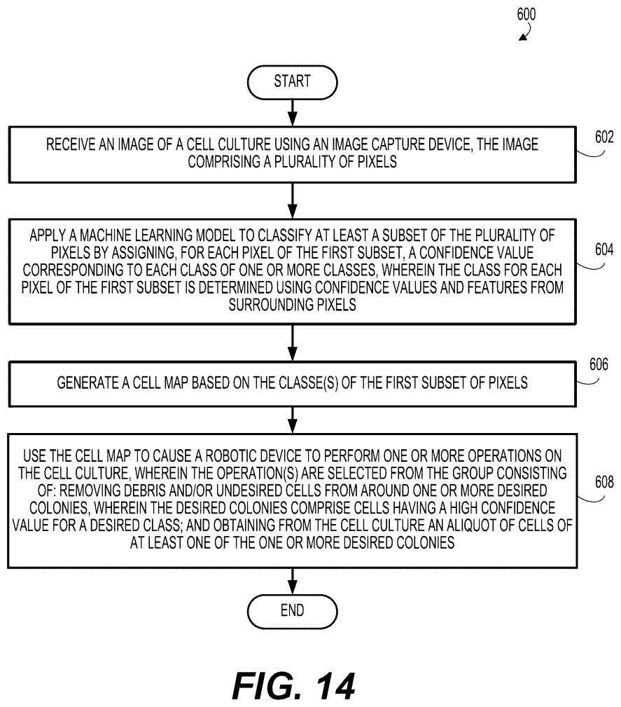

FIG. 14 is a flowchart of an example method 600 that uses the systems and models disclosed herein for performing automated classification and handling of cells. For example, method 600 may be performed by one or more components of system 200, such as user device 202, computing system 300, robotic device 400, and image capture device 204.

In block 602, the method can include receiving an image of a cell culture (e.g., image 500, FIG. 13) using an image capture device (e.g., image capture device 204), the image including a plurality of pixels.

In block 604, the method can include applying a machine learning model (e.g., model 318 of computing system 300) to classify at least a subset of the plurality of pixels by assigning, for each pixel of the first subset, a confidence value corresponding to each class of one or more classes. As further discussed herein, the class for each pixel can be determined using the assigning of confidence values and selecting the highest confidence value for each pixel.

As discussed herein, in some embodiments, the one or more classes may include iPSC, differentiated, unknown, and/or background, where the desired class is iPSC. As discussed herein, in some embodiments, the one or more classes may include iPSC, DANPC, unknown, and/or background, where the desired class is DANPC. In some embodiments, the machine learning model may classify each pixel into one of the classes based on one or more features of relevant pixels, such as surrounding pixels. In some embodiments, the feature(s) may be based at least in part on contextual features extracted from a spatial neighborhood of each evaluated pixel. These features can include, for example, the classification of such surrounding pixels, and/or a distance between each pixel and one or more of the surrounding pixels, as further discussed below.

In some embodiments, block 604 can include receiving a request for N pick points and selection constraint(s). These selection constraint(s) may include a pick point diameter and/or a minimum distance to one or more pixels that are classified as off-target pixels. The off-target pixels can correspond to, for example, background, debris, unknown, and/or an undesired class of cells. In some embodiments, the minimum distance for a first type of off-target pixel can be different from the minimum distance for a second type of off-target pixel. In some embodiments, block 604 can further include identifying one or more preferred pixels that are a subset of pixels classified as those of the desired class. Such identification can include (i) ranking the pixels by their confidence value for the desired class, (ii) selecting the top N pixels satisfying the selection constraints, and (iii) dynamically determining a confidence threshold equal to the confidence value for the Nth-ranked pixel. In some embodiments, certain areas of the cell culture might be selected based on their inclusion of mostly high confidence iPSCs but may also contain cells of an unknown class. In such instances, those areas may still be selected for purposes of improving process efficiency and/or robustness.

In some embodiments, the method may include applying a minimum fixed confidence threshold for selecting the preferred pixel(s) in addition to the dynamically determined confidence threshold.

In some embodiments, the system may generate a heatmap overlay of the confidence values that can be used for visualization and user verification.

In block 606, the method can include generating a cell map based on the class or classes of the first subset of pixels. Such cell map is configured to show the location of each cell within the culture. In some embodiments, this step may further include generating a second cell map based on one or more of the preferred pixels (block 604).

In block 608, the method can include using the cell map (based on the classes of the first subset of pixels) to cause a robotic device to perform one or more operations on the cell culture. For example, robotic device 400 can be used to remove debris and/or undesired cells from around desired colonies, where the desired colonies include cells having a high confidence value for the desired class. The debris can include, for example, differentiated cells, dead cells, and/or unknown cells. As another example, robotic device 400 can be used to obtain from the cell culture an aliquot of cells of one or more of the desired colonies. Removal of such debris and/or undesired cells can help improve the overall health of the cell culture. In some embodiments, the step of removing the debris and/or undesired cells can be performed before obtaining the aliquot of cells from the cell culture. Robotic device 400 may perform such operations by moving the axis 402, microscopy stage 406, and air displacement pipette 408 in tandem. In some embodiments, the robotic device 400 may use its micromanipulator 414 to approach the desired cell colonies along a planar trajectory and perform suction- or pipette-based extraction of the cells having a high confidence value for the desired class. The desired colonies may correspond to one or more preferred pixels on the cell map.

In some embodiments, the method can include the system autonomously generating a cleaning path around one or more of the desired colonies. The cleaning path can help to provide instructions to the robotic device to clean around the desired cell colonies that are shown on the cell map, as discussed above with respect to FIGS. 6 and 7A-7B. The robotic device may move an extraction device (e.g., pipette 408) along the cleaning path to remove the debris and/or undesired cells from around the desired colonies. As discussed herein, the cleaning path may include an inner boundary enclosing the desired colony, and an outer boundary that encloses the inner boundary and defines a cleaning perimeter around the desired colony. The inner and outer boundaries may be spaced apart by some predefined margin, where the area between the boundaries forms a cleaning zone. As discussed herein, the cleaning path can take the shape of a closed polygon, a square, circle, rectangle, triangle, ellipse, parallelogram, rhombus, pentagon, hexagon, heptagon, octagon, nonagon, decagon, kite, or another shape.

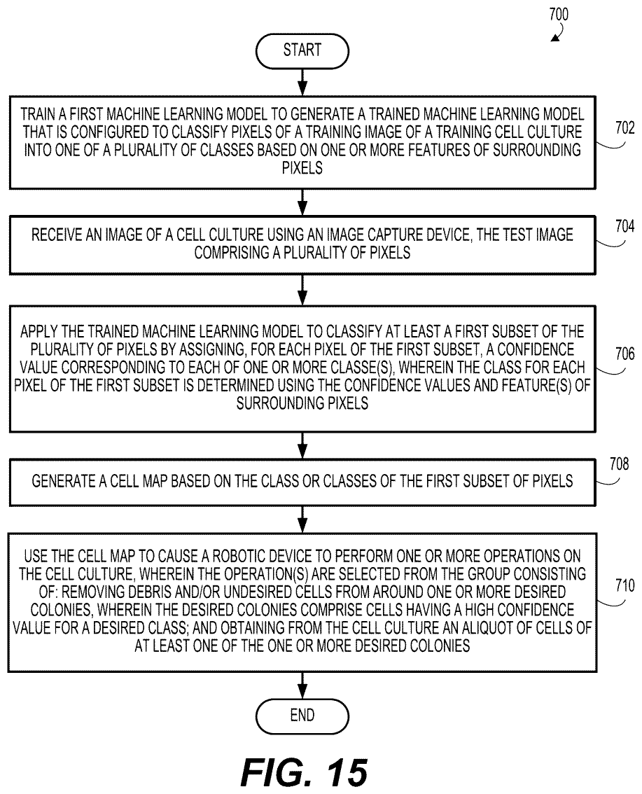

FIG. 15 is a flowchart of an example method 700 that uses the systems and models disclosed herein for performing automated classification and handling of cells. For example, method 700 may be performed by one or more components of system 200, such as user device 202, computing system 300, robotic device 400, and image capture device 204. The descriptions of blocks 706, 708, and 710 of method 700 may be the same as or similar to the respective descriptions of block 604, 606, and 608 of method 600 and as such, are not included herein for brevity.

In block 702, the method may include training a first machine learning model to generate a trained machine learning model that is configured to classify pixels of a training image of a training cell culture into one or more (e.g., a plurality of) classes, for example, based on one or more features of surrounding or other relevant pixels. As discussed herein, the first machine learning model may be one of a variety of model types, such as a DNN (e.g., a CNN or ViT). The model can first be trained to identify basic structures in a series of training images, and then be fine-tuned to understand microscopy images in particular. The model can be trained to evaluate not only specific components of images, but also surrounding features of those components. This is helpful in that the trained model can then identify specific pixels as well as surrounding features (e.g., distances, boundaries, etc.) of those pixels, as discussed herein.

In block 704, the method may include receiving an image (e.g., a test image) of a cell culture (e.g., a test cell culture) using an image capture device, the image comprising a plurality of pixels. This step may be the same as or similar to block 602 of method 600.

In some examples, disclosed systems or methods may involve one or more of the following clauses:

Clause 1: A system comprising: one or more processors; and a memory operably coupled to the one or more processors, wherein the memory stores: i) a machine learning model that is configured to classify pixels of an image of a cell culture into one or more classes based on one or more features of surrounding pixels, and ii) instructions that, when executed by the one or more processors, cause the system to: a) receive an image of a cell culture using an image capture device, the image comprising a plurality of pixels; b) apply the machine learning model to classify at least a first subset of the plurality of pixels by assigning, for each pixel of the first subset, a confidence value corresponding to each of one or more classes, wherein the class for each pixel of the first subset is determined using the confidence values and the one or more features of the surrounding pixels; c) generate a cell map based on the class or classes of the first subset of the plurality of pixels; d) use the cell map to cause a robotic device to perform one or more operations on the cell culture, wherein the operations are selected from the group consisting of: i) removing one or more of debris and undesired cells from around one or more desired colonies, wherein the one or more desired colonies comprise cells having a high confidence value for a desired class; and ii) obtaining from the cell culture an aliquot of cells of at least one of the one or more desired colonies.

Clause 2: The system of clause 1, wherein the one or more classes comprises one or more of: induced pluripotent stem cell (iPSC), differentiated, unknown, and background, or combinations thereof.

Clause 3: The system of any of clauses 1-2, wherein the desired class is iPSC.

Clause 4: The system of clause 1, wherein the one or more classes comprises one or more of iPSC, dopaminergic neuronal progenitor cell (DANPC), unknown, and background, or combinations thereof.

Clause 5: The system of any of clauses 1 and 4, wherein the desired class is DANPC.

Clause 6: The system of any of clauses 1-5, wherein the image is divided into a plurality of sections, each section comprising one or more pixels of the plurality of pixels.

Clause 7: The system of any of clauses 1-6, wherein step d) comprises first removing one or more of the debris and the undesired cells from around the one or more desired colonies, and then obtaining from the cell culture the aliquot of cells of at least one of the one or more desired colonies.

Clause 8: The system of any of clauses 1-7, wherein: step b) comprises: a) receiving a request for N pick points and one or more selection constraints, the one or more selection constraints comprising at least one of: a pick point diameter and a minimum distance to one or more pixels that are classified as off-target pixels; and b) identifying one or more preferred pixels, wherein the one or more preferred pixels comprise a second subset of pixels having a high confidence value for the desired class by: i) ranking the pixels by their confidence value for the desired class; ii) selecting the top N pixels satisfying the one or more selection constraints; and iii) dynamically determining a confidence threshold equal to the confidence value for the Nth-ranked pixel; and step d) comprises updating the cell map based on one or more of the preferred pixels.

Clause 9: The system of clause 8, wherein the off-target pixels correspond to one or more of background, debris, unknown, an undesired class of cells, or a combination thereof.

Clause 10: The system of any of clauses 8-9, wherein the minimum distance for a first type of off-target pixel is different than the minimum distance for a second type of off-target pixel.

Clause 11: The system of any of clauses 8-10, wherein the one or more processors are configured to apply a minimum fixed confidence threshold for selecting the one or more preferred pixels in addition to the dynamically determined confidence threshold.

Clause 12: The system of any of clauses 8-11, wherein the robotic device comprises a micromanipulator configured to approach the one or more desired colonies along a planar trajectory and perform suction- or pipette-based extraction of the cells having a high confidence value for the desired class, wherein the one or more desired colonies correspond to one or more of the preferred pixels on the cell map.

Clause 13: The system of any of clauses 1-12, wherein the one or more processors are configured to autonomously generate a cleaning path around the one or more desired colonies, and step d) comprises moving an extraction device along the cleaning path to remove one or more of the debris and the undesired cells from around the one or more desired colonies.

Clause 14: The system of clause 13, wherein the cleaning path comprises an inner boundary that encloses a first desired colony, and an outer boundary that encloses the inner boundary and defines a cleaning perimeter around the first desired colony.

Clause 15: The system of clause 14, wherein the outer boundary is spaced apart from the inner boundary by a predefined margin, the area between the boundaries forming a cleaning zone.

Clause 16: The system of any of clauses 13-15, wherein the cleaning path has a shape of a closed polygon, a square, circle, rectangle, triangle, ellipse, parallelogram, rhombus, pentagon, hexagon, heptagon, octagon, nonagon, decagon, or kite.

Clause 17: The system of any of clauses 1-16, wherein the processors are further configured to generate a heatmap overlay of the confidence values for visualization and user verification.

Clause 18: The system of any of clauses 1-17, wherein the machine learning model comprises a Deep Neural Network (DNN).

Clause 19: The system of clause 18, wherein the DNN comprises a Vision Transformer (ViT) or a Convolutional Neural Network (CNN).

Clause 20: The system of any of clauses 1-19, wherein the debris comprises one or more of differentiated cells, dead cells, and unknown cells.

Clause 21: The system of any of clauses 1-20, wherein the image capture device comprises a microscope.

Clause 22: A system comprising: one or more processors; and a memory operably coupled to the one or more processors, wherein the memory stores instructions that, when executed by the one or more processors, cause the system to: a) train a first machine learning model to generate a trained machine learning model that is configured to classify pixels of a training image of a training cell culture into one or more classes based on one or more features of surrounding pixels; b) receive an image of a cell culture using an image capture device, the image comprising a plurality of pixels; c) apply the trained machine learning model to classify at least a first subset of the plurality of pixels by assigning, for each pixel of the first subset, a confidence value corresponding to each of the one or more classes, wherein the class for each pixel of the first subset is determined using the confidence values and the one or more features of the surrounding pixels; d) generate a cell map based on the class or classes of the first subset of the plurality of pixels; e) use the cell map to cause a robotic device to perform one or more operations on the cell culture, wherein the operations are selected from the group consisting of: i) removing one or more of debris and undesired cells from around one or more desired colonies, wherein the one or more desired colonies comprise cells having a high confidence value for a desired class; and ii) obtaining from the cell culture an aliquot of cells of at least one of the one or more desired colonies.

Clause 23: The system of clause 22, wherein the one or more classes comprise one or more of: induced pluripotent stem cell (iPSC), differentiated, unknown, and background, or combinations thereof.

Clause 24: The system of any of clauses 22-23, wherein the desired class is iPSC.

Clause 25: The system of clause 22, wherein the one or more classes comprise one or more of iPSC, dopaminergic neuronal progenitor cell (DANPC), unknown, and background, or combinations thereof.

Clause 26: The system of any of clauses 1and 25, wherein the desired class is DANPC.

Clause 27: The system of any of clauses 22-26, wherein step e) comprises first removing one or more of the debris and the undesired cells from around the one or more desired colonies, and then obtaining from the cell culture the aliquot of cells of at least one of the one or more desired colonies.

Clause 28: The system of any of clauses 22-27, wherein: step c) comprises: a) receiving a request for N pick points and one or more selection constraints, the one or more selection constraints comprising at least one of: a pick point diameter and a minimum distance to one or more pixels that are classified as off-target pixels; and b) identifying one or more preferred pixels, wherein the one or more preferred pixels comprise a second subset of pixels having a high confidence value for the desired class by: i) ranking the pixels by their confidence value for the desired class; ii) selecting the top N pixels satisfying the one or more selection constraints; and iii) dynamically determining a confidence threshold equal to the confidence value for the Nth-ranked pixel; and step d) comprises updating the cell map based on one or more of the preferred pixels.

Clause 29: The system of clause 28, wherein the off-target pixels correspond to one or more of background, debris, unknown, an undesired class of cells, or a combination thereof.

Clause 30: The system of any of clauses 28-29, wherein the minimum distance for a first type of off-target pixel is different than the minimum distance for a second type of off-target pixel.

Clause 31: The system of any of clauses 28-30, wherein the one or more processors are configured to apply a minimum fixed confidence threshold for selecting the preferred pixels in addition to the dynamically determined confidence threshold.

Clause 32: the System of Any of Clauses 28-31, wherein the robotic device comprises a micromanipulator configured to approach the one or more desired colonies along a planar trajectory and perform suction- or pipette-based extraction of the cells of the one or more desired colonies, wherein the one or more desired colonies correspond to one or more of the preferred pixels on the cell map.

Clause 33: The system of any of clauses 22-32, wherein the one or more processors are configured to autonomously generate a cleaning path around the one or more desired colonies, and step e) comprises moving an extraction device along the cleaning path to remove one or more of the debris and the undesired cells from around the one or more desired colonies.

Clause 34: The system of clause 33, wherein the cleaning path comprises an inner boundary that encloses a first desired colony, and an outer boundary that encloses the inner boundary and defines a cleaning perimeter around the first desired colony.

Clause 35: The system of clause 34, wherein the outer boundary is spaced apart from the inner boundary by a predefined margin, the area between the boundaries forming a cleaning zone.

Clause 36: The system of any of clauses 33-35, wherein the cleaning path has a shape of a closed polygon, square, circle, rectangle, triangle, ellipse, parallelogram, rhombus, pentagon, hexagon, heptagon, octagon, nonagon, decagon, or kite.

Clause 37: the system of any of clauses 22-36, wherein the one or more processors are further configured to generate a heatmap overlay of the confidence values for visualization and user verification.

Clause 38: The system of any of clauses 22-37, wherein the first machine learning model comprises a Deep Neural Network (DNN).

Clause 39: The system of clause 38, wherein the DNN comprises a Vision Transformer (ViT) or a Convolutional Neural Network (CNN).

Clause 40: The system of any of clauses 22-39, wherein the debris comprises one or more of differentiated cells and unknown cells.

Clause 41: the system of any of clauses 22-40, wherein the image capture device comprises a microscope.

Clause 42: The system of clause 22, wherein the instructions are further configured to cause the one or more processors to update the trained machine learning model based on the classification of one or more pixels of the image.

Clause 43: A method comprising: a) receiving an image of a cell culture using an image capture device, the image comprising a plurality of pixels; b) applying a machine learning model to classify each pixel of at least a first subset of the plurality of pixels by assigning, for each pixel of the first subset, a confidence value corresponding to each of one or more classes, wherein the class for each pixel of the first subset is determined using the confidence values and one or more features of surrounding pixels; c) generating a cell map based on the class or classes of the first subset of pixels; d) using the cell map to cause a robotic device to perform one or more operations on the cell culture, wherein the operations are selected from the group consisting of: i) removing one or more of debris and undesired cells from around one or more desired colonies, wherein the one or more desired colonies comprise cells having a high confidence value for a desired class; and ii) obtaining from the cell culture an aliquot of cells of at least one of the one or more desired colonies.

Clause 44: The method of clause 43, wherein the one or more classes comprises one or more of: induced pluripotent stem cell (iPSC), differentiated, unknown, and background, or combinations thereof.

Clause 45: The method of any of clauses 43-44, wherein the desired class is iPSC.

Clause 46: The method of clause 43, wherein the one or more classes comprises one or more of iPSC, dopaminergic neuronal progenitor cell (DANPC), unknown, and background, or combinations thereof.

Clause 47: The method of any of clauses 43 and 46, wherein the desired class is DANPC.

Clause 48: The method of any of clauses 43-47, wherein step d) comprises first removing one or more of the debris and the undesired cells from around the one or more desired colonies, and then obtaining from the cell culture the aliquot of cells of at least one of the one or more desired colonies.

Clause 49: The method of any of clauses 43-48, further comprising: dynamically determining a confidence threshold by: a) receiving a request for N pick points and one or more selection constraints, the one or more selection constraints comprising at least one of: a pick point diameter and a minimum distance to one or more pixels that are classified as off-target pixels; b) identifying one or more preferred pixels, wherein the one or more preferred pixels comprise a second subset of pixels having a high confidence value for the desired class by: i) ranking the pixels by their confidence value for the desired class; ii) selecting the top N pixels satisfying the one or more selection constraints; and iii) dynamically determining a confidence threshold equal to the confidence value for the Nth-ranked pixel; and c) updating the cell map based on one or more of the preferred pixels.

Clause 50: The method of clause 49, wherein the off-target pixels correspond to one or more of background, debris, unknown, an undesired class of cells, or a combination thereof.

Clause 51: the method of any of clauses 49-50, wherein the minimum distance for a first type of off-target pixel is different than the minimum distance for a second type of off-target pixel.

Clause 52: The method of any of clauses 49-51, further comprising: applying a minimum fixed confidence threshold for selecting the one or more preferred pixels in addition to dynamically determining the confidence threshold.

Clause 53: The method of any of clauses 49-52, wherein the robotic device comprises a micromanipulator configured to approach the one or more desired colonies along a planar trajectory and perform suction- or pipette-based extraction of one or more preferred cells, wherein the one or more preferred cells correspond to one or more of the preferred pixels on the cell map.

Clause 54: The method of any of clauses 43-53, further comprising: autonomously generating a cleaning path around the one or more desired colonies, wherein step e) further comprises moving an extraction device along the cleaning path to remove one or more of the debris and the undesired cells from around the one or more desired colonies.

Clause 55: The method of clause 54, wherein the cleaning path comprises an inner boundary that encloses one or more of the desired colonies, and an outer boundary that encloses the inner boundary and defines a cleaning perimeter around one or more of the desired colonies.

Clause 56: The method of clause 55, wherein the outer boundary is spaced apart from the inner boundary by a predefined margin, the area between the boundaries forming a cleaning zone.

Clause 57: The method of any of clauses 54-56, wherein the cleaning path has a shape of a closed polygon, square, circle, rectangle, triangle, ellipse, parallelogram, rhombus, pentagon, hexagon, heptagon, octagon, nonagon, decagon, or kite.

Clause 58: The method of any of clauses 43-57, further comprising: generating a heatmap overlay of the confidence values for visualization and user verification.

Clause 59: The method of any of clauses 43-58, wherein the machine learning model comprises a Deep Neural Network (DNN).

Clause 60: The method of clause 59, the DNN comprises a Vision Transformer (ViT) or a Convolutional Neural Network (CNN).

Clause 61: The method of any of clauses 43-60, wherein the debris comprises one or more of differentiated cells and unknown cells.

Clause 62: The method of any of clauses 43-61, wherein the image capture device comprises a microscope.

Clause 63: A method comprising: a) training a first machine learning model to generate a trained machine learning model that is configured to classify pixels of a training image of a training cell culture into one of a plurality of classes based on one or more features of surrounding pixels; b) receiving an image of a cell culture using an image capture device, the image comprising a plurality of pixels; c) applying the trained machine learning model to classify at least a first subset of the plurality of pixels by assigning, for each pixel of the first subset, a confidence value corresponding to each of the plurality of classes, wherein the class for each pixel of the first subset is determined using the confidence values and the one or more features of the surrounding pixels; d) generating a cell map based on the class or classes of the first subset of pixels; e) using the cell map to cause a robotic device to perform one or more operations on the cell culture, wherein the operations are selected from the group consisting of: i) removing one or more of debris and undesired cells from around one or more desired colonies, wherein the one or more desired colonies comprise cells having a high confidence value for a desired class; and ii) obtaining from the cell culture an aliquot of cells of at least one of the one or more desired colonies.

Clause 64: The method of clause 63, wherein the plurality of classes comprises one or more of: induced pluripotent stem cell (iPSC), differentiated, unknown, and background, or combinations thereof.

Clause 65: The method of any of clauses 63-64, wherein the desired class is iPSC.

Clause 66: The method of clause 63, wherein the plurality of classes comprises one or more of iPSC, dopaminergic neuronal progenitor cell (DANPC), unknown, and background, or combinations thereof.

Clause 67: The method of any of clauses 63 and 66, wherein the desired class is DANPC.

Clause 68: The method of any of clauses 63-67, wherein step e) comprises first removing one or more of the debris and the undesired cells from around the one or more desired colonies, and then obtaining from the cell culture the aliquot of cells of at least one of the one or more desired colonies.

Clause 69: The method of any of clauses 63-68, further comprising: dynamically determining a confidence threshold by: a) receiving a request for N pick points and one or more selection constraints, the one or more selection constraints comprising at least one of: a pick point diameter and a minimum distance to one or more pixels that are classified as off-target pixels; b) identifying one or more preferred pixels, wherein the one or more preferred pixels comprise a second subset of pixels classified as pixels of the desired class by: i) ranking the pixels by their confidence value for the desired class; ii) selecting the top N pixels satisfying the one or more selection constraints; and iii) dynamically determining a confidence threshold equal to the confidence value for the Nth-ranked pixel; and c) updating the cell map based on one or more of the preferred pixels.

Clause 70: The method of clause 69, wherein the off-target pixels correspond to one or more of background, debris, unknown, an undesired class of cells, or a combination thereof.

Clause 71: The method of any of clauses 69-70, wherein the minimum distance for a first type of off-target pixel is different than the minimum distance for a second type of off-target pixel.

Clause 72: The method of any of clauses 69-71, further comprising: applying a minimum fixed confidence threshold for selecting the one or more preferred pixels in addition to dynamically determining the confidence threshold.

Clause 73: The method of any of clauses 69-72, wherein the robotic device comprises a micromanipulator configured to approach preferred cells in the cell culture along a planar trajectory and perform suction- or pipette-based extraction of the preferred cells, wherein the preferred cells correspond to one or more of the preferred pixels on the cell map.

Clause 74: The method of any of clauses 63-73, further comprising: autonomously generating a cleaning path around the one or more desired colonies, wherein step e) further comprises moving an extraction device along the cleaning path to remove one or more of the debris and the undesired cells from around the one or more desired colonies.

Clause 75: The method of clause 74, wherein the cleaning path comprises an inner boundary that encloses a first desired colony, and an outer boundary that encloses the inner boundary and defines a cleaning perimeter around the first desired colony.

Clause 76: The method of clause 75, wherein the outer boundary is spaced apart from the inner boundary by a predefined margin, the area between the boundaries forming a cleaning zone.

Clause 77: The method of any of clauses 74-76, wherein the cleaning path has a shape of a closed polygon, square, circle, rectangle, triangle, ellipse, parallelogram, rhombus, pentagon, hexagon, heptagon, octagon, nonagon, decagon, or kite.

Clause 78: The method of any of clauses 63-77, further comprising: generating a heatmap overlay of the confidence values for visualization and user verification.

Clause 79: The method of any of clauses 63-78, wherein the first machine learning model comprises a Deep Neural Network (DNN).

Clause 80: The method of clause 79, wherein the DNN comprises a Vision Transformer (ViT) or a Convolutional Neural Network (CNN).

Clause 81: The method of any of clauses 63-80, wherein the debris comprises one or more of differentiated cells and unknown cells.

Clause 82: The method of any of clauses 63-81, wherein the image capture device comprises a microscope.

While preferred embodiments of the present invention have been shown and described herein, it will be understood to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby. All publications, patents, and patent application publications cited in this application are incorporated herein by reference in their entirety for all purposes.

1. A system comprising:
one or more processors; and
a memory operably coupled to the one or more processors, wherein the memory stores: i) a machine learning model that is configured to classify pixels of an image of a cell culture into one or more classes based on one or more features of surrounding pixels, and ii) instructions that, when executed by the one or more processors, cause the system to:
a) receive an image of a cell culture using an image capture device, the image comprising a plurality of pixels;
b) apply the machine learning model to classify at least a first subset of the plurality of pixels by assigning, for each pixel of the first subset, a confidence value corresponding to each of one or more classes, wherein the class for each pixel of the first subset is determined using the confidence values and the one or more features of the surrounding pixels;
c) generate a cell map based on the class or classes of the first subset of the plurality of pixels;
d) use the cell map to cause a robotic device to perform one or more operations on the cell culture, wherein the operations are selected from the group consisting of:
i) removing one or more of debris and undesired cells from around one or more desired colonies, wherein the one or more desired colonies comprise cells having a high confidence value for a desired class; and
ii) obtaining from the cell culture an aliquot of cells of at least one of the one or more desired colonies.

2. The system of claim 1, wherein the one or more classes comprises one or more of: induced pluripotent stem cell (iPSC), differentiated, unknown, and background, or combinations thereof.

3. The system of claim 2, wherein the desired class is iPSC.

4. The system of claim 1, wherein the one or more classes comprises one or more of iPSC, dopaminergic neuronal progenitor cell (DANPC), unknown, and background, or combinations thereof.

5. The system of claim 4, wherein the desired class is DANPC.

6. The system of claim 1, wherein the image is divided into a plurality of sections, each section comprising one or more pixels of the plurality of pixels.

7. The system of claim 1, wherein step d) comprises first removing one or more of the debris and the undesired cells from around the one or more desired colonies, and then obtaining from the cell culture the aliquot of cells of at least one of the one or more desired colonies.

8. The system of claim 1, wherein: step b) comprises:
a) receiving a request for N pick points and one or more selection constraints, the one or more selection constraints comprising at least one of: a pick point diameter and a minimum distance to one or more pixels that are classified as off-target pixels; and
b) identifying one or more preferred pixels, wherein the one or more preferred pixels comprise a second subset of pixels having a high confidence value for the desired class by:
i) ranking the pixels by their confidence value for the desired class;
ii) selecting the top N pixels satisfying the one or more selection constraints; and
iii) dynamically determining a confidence threshold equal to the confidence value for the Nth-ranked pixel; and
step d) comprises updating the cell map based on one or more of the preferred pixels.

9. The system of claim 8, wherein the off-target pixels correspond to one or more of background, debris, unknown, an undesired class of cells, or a combination thereof.

10. The system of claim 8, wherein the minimum distance for a first type of off-target pixel is different than the minimum distance for a second type of off-target pixel.

11. The system of claim 8, wherein the one or more processors are configured to apply a minimum fixed confidence threshold for selecting the one or more preferred pixels in addition to the dynamically determined confidence threshold.

12. The system of claim 8, wherein the robotic device comprises a micromanipulator configured to approach the one or more desired colonies along a planar trajectory and perform suction- or pipette-based extraction of the cells having a high confidence value for the desired class, wherein the one or more desired colonies correspond to one or more of the preferred pixels on the cell map.

13. The system of claim 1, wherein the one or more processors are configured to autonomously generate a cleaning path around the one or more desired colonies, and step d) comprises moving an extraction device along the cleaning path to remove one or more of the debris and the undesired cells from around the one or more desired colonies.

14. The system of claim 13, wherein the cleaning path comprises an inner boundary that encloses a first desired colony, and an outer boundary that encloses the inner boundary and defines a cleaning perimeter around the first desired colony.

15. The system of claim 14, wherein the outer boundary is spaced apart from the inner boundary by a predefined margin, the area between the boundaries forming a cleaning zone.

16. The system of claim 13, wherein the cleaning path has a shape of a closed polygon, a square, circle, rectangle, triangle, ellipse, parallelogram, rhombus, pentagon, hexagon, heptagon, octagon, nonagon, decagon, or kite.

17. The system of claim 1, wherein the processors are further configured to generate a heatmap overlay of the confidence values for visualization and user verification.

18. The system of claim 1, wherein the machine learning model comprises a Deep Neural Network (DNN).

19. The system of claim 18, wherein the DNN comprises a Vision Transformer (ViT) or a Convolutional Neural Network (CNN).

20. The system of claim 1, wherein the debris comprises one or more of differentiated cells, dead cells, and unknown cells.

21. The system of claim 1, wherein the image capture device comprises a microscope.
